(19) United States
(12) Patent Application Publication
(10) Pub. No.: US 2021/0142168 A1
(43) Pub. Date: May 13, 2021

(54) METHODS AND APPARATUSES FOR TRAINING NEURAL NETWORKS

(71) Applicant: Nokia Technologies OY, Espoo (FI)

(72) Inventors: Dan KUSHNIR, Springfield, NJ (US); Luca VENTURI, New York, NY (US)

(73) Assignee: Nokia Technologies OY, Espoo (FI)

(21) Appl. No.: 16/987,892

(22) Filed: Aug. 7, 2020

Related U.S. Application Data
(60) Provisional application No. 62/931,994, filed on Nov. 7, 2019.

(51) Int. Cl. G06N 3/08; G06N 3/04; G06N 3/063

(52) U.S. Cl. CPC G06N 3/08; G06N 3/063; G06N 3/0454

(57) ABSTRACT

Method of classifying data may include training, by processing circuitry, a neural network based on labeled inputs of a training data set; identifying, by the processing circuitry, a refinement subset of unlabeled inputs of a pool data set by determining, for each unlabeled input, a first distance of the unlabeled input to the labeled inputs of the training data set and a second distance of the unlabeled input to other unlabeled inputs of the pool data set; submitting, by the processing circuitry, the refinement subset to a labeling process to produce a labeled subset; training, by the processing circuitry, the neural network based on the labeled subset to produce a trained neural network; and classifying, by the processing circuitry, new data using the trained neural network.

### PRIORITY INFORMATION

This application claims priority from U.S. Provisional Application No. 62/931,994, filed Nov. 7, 2019, the contents of which are incorporated herein by reference in their entirety.

### BACKGROUND

### 1. Field

Various example embodiments relate generally to methods and apparatuses for active learning for deep learning training of neural networks using a training data set, wherein trained neural networks may be used to classify new data in a similar manner as the training data set.

### 2. Related Art

In the field of machine learning, many scenarios involve neural networks that are organized as a set of layers, such as an input layer that receives an input, one or more hidden layers that process the input based on weighted connections with the neurons of a preceding layer, and an output layer that generates an output that may indicate a classification of the input. As an example, each input may be classified into one of N classes by providing an output layer with N neurons, where the neuron of the output layer having a maximum output indicates the class into which the input is classified.

Neural networks may be trained to classify data through a learning process. As an example involving fully-connected layers, each neuron of a layer is connected to each and every neuron of a preceding layer, and each connection includes a weight that is initially set to a value, such as a random value. Each neuron determines a weighted sum of the weighted inputs of the preceding layer and provides an output based on the weighted sum and an activation function, such as a linear activation, a rectified linear activation, a sigmoid activation, and/or a softmax activation. The output layer may similarly generate an output based on the weighted sum and an activation function.

A training data set of inputs with labels (for example, the expected classification of each input) is provided to train the neural network. Each input is processed by the neural network, wherein a backpropagation process is performed to adjust the weights of each layer such that the output is closer to the label. Some training processes may involve dividing the inputs of the training data set into mini-batches and performing backpropagation on an aggregate of the outputs for the inputs of each mini-batch. Continued training may be performed until the neural network converges, such that the neural network may produce output that is at least close to the label for each input. A neural network that is trained to perform discriminant analysis between two or more classes may form a decision boundary in an input space or sample space, wherein inputs that are on one side of the decision boundary, for example, are classified into a first class and inputs that are on another side of the decision boundary are classified into a second class. When the neural network is fully trained, new data may be provided, such as inputs without known labels, and the neural network may classify the new data based upon the training over the training data set.

The field of deep learning includes a significant number of hidden layers and/or a significant number of neurons, which may enable a more complex classification process, such as the classification of high-dimensionality input. The number of weights (also known as parameters) and/or the number of inputs in the training data set may be large, such that the training may take a long time to converge. An extended duration of training may delay the availability of a trained neural network, and/or may be computationally expensive, such as consuming significant computational resources such as processing capacity, memory capacity, network capacity, and/or energy usage to apply training until the neural network converges.

As an example, a neural network may be trained to identify events in an image, or in a sequence of images such as a video. As an example in the field of autonomous vehicle navigation, the events may include an occurrence of a traffic signal such as a stoplight, a pedestrian entering a sidewalk, and/or an occurrence of a road hazard such as a stopped vehicle or debris in a lane of a road. A training data set may be prepared as a set of labeled inputs, where each input includes an image or video and one or more labels indicating the events that are depicted as occurring in the image or video.

A training process may be executed to train the neural network to classify each labeled input based upon the labels, and if the neural network converges during the training process, the neural network may be capable of recognizing the events that arise in each picture or video within a selected range of accuracy and/or confidence. In some cases, the neural network may converge based upon training using only the training data set. However, in some other cases, the neural network may not adequately converge based upon using only the training data set, and it may be desirable to provide additional training data to continue the training and/or to refine the proficiency of the neural network. Such additional training may depend upon additional labeled input, which may be obtained by labeling some unlabeled inputs in a pool data set. Because labeling the unlabeled inputs may be a resource-intensive process (e.g., involving a delay while the unlabeled inputs are labeled and/or a cost in terms of processing capacity utilization and/or human attention), it may not be desirable to initiate labeling of an entire pool data set, but rather to select a subset of the unlabeled inputs to be labeled for the continued training of the neural network. The continued training may result in convergence and the production of a fully trained neural network, which may be provided new data in the form of images or video from a camera of an autonomous vehicle. Processing of the neural network to classify the events arising in the new data may inform the operation of the autonomous vehicle, for example, in order to comply with traffic signals, to yield to pedestrians in crosswalks, and to avoid collisions with stopped vehicles and/or debris.

### SUMMARY

Some example embodiments may include methods of classifying data, including training, by processing circuitry, a neural network based on labeled inputs of a training data set and unlabeled inputs of a pool data set to produce a partially trained neural network; generating, by the processing circuitry, a proximity graph of the labeled inputs of the training data set and the unlabeled inputs of the pool data set based on similarities of output from a hidden layer of the neural network for each of the labeled inputs and each of the unlabeled inputs; diffusing, by the processing circuitry, labels from the labeled inputs to the unlabeled inputs based on the proximity graph to identify a refinement subset of the unlabeled inputs; submitting, by the processing circuitry, the refinement subset to a labeling process to produce a labeled subset; further training, by the processing circuitry, the partially trained neural network based on the labeled subset to produce a trained neural network; and classifying, by the processing circuitry, new data using the trained neural network.

Some example embodiments may include methods of classifying data, including training, by processing circuitry, a neural network based on labeled inputs of a training data set; identifying, by the processing circuitry, a refinement subset of unlabeled inputs of a pool data set by determining, for each unlabeled input of the pool data set, a first distance of the unlabeled input to the labeled inputs of the training data set, and a second distance of the unlabeled input to other unlabeled inputs of the pool data set; submitting, by the processing circuitry, the refinement subset to a labeling process to produce a labeled subset; training, by the processing circuitry, the neural network based on the labeled subset to produce a trained neural network; and classifying, by the processing circuitry, new data using the trained neural network.

Some example embodiments may include apparatuses that classify data, including a memory storing a training data set including labeled inputs and a pool data set including unlabeled inputs; and processing circuitry configured to train a neural network based on the labeled inputs of the training data set; identify a refinement subset of the unlabeled inputs of the pool data set by determining, for each unlabeled input of the unlabeled inputs of the pool data set, a first distance of the unlabeled input to the labeled inputs of the training data set, and a second distance of the unlabeled input to other unlabeled inputs of the pool data set; submit the refinement subset to a labeling process to produce a labeled subset; train the neural network based on the labeled subset to produce a trained neural network; and classify new data using the trained neural network.

In some example embodiments, the identifying may include generating, a proximity graph of the labeled inputs of the training data set and the unlabeled inputs of the pool data set based on similarities of output from a hidden layer of the neural network for each of the labeled inputs and each of the unlabeled inputs; diffusing labels from the labeled inputs to the unlabeled inputs based on the proximity graph, wherein the diffusing for each unlabeled input may be based on the first distance and the second distance; and adding unlabeled input to the refinement subset based on the diffusing.

In some example embodiments, the neural network may include a sequence of layers including an output layer and a hidden layer connected to the output layer, and the generating of the proximity graph may be based on similarities of output of each input from the hidden layer of the neural network.

In some example embodiments, the sequence of layers may further include a second hidden layer connected to the hidden layer of the neural network, and the proximity graph is based on similarities of output of each input from the second hidden layer to the hidden layer.

In some example embodiments, the diffusing of the labels from the labeled inputs to an unlabeled input includes assigning a value for each label, and generating a weighted sum of the value for each label diffused to the unlabeled input, wherein the identifying identifies the unlabeled inputs having a weighted sum with an absolute value that is below a threshold as the refinement subset.

In some example embodiments, the sequence of layers may further include at least two hidden layers that are interconnected; the generating of the proximity graph may include a hidden layer proximity graph for each hidden layer of the at least two hidden layers based on similarities of output from the each hidden layer for each input; and the identifying of the refinement subset may include, for each unlabeled input, calculating a weighted sum of the value based on the hidden layer proximity graphs of each of the at least two hidden layers, and identifying the refinement subset as the unlabeled inputs of the pool data set having a minimum weighted sum as compared with other inputs of the pool data set.

In some example embodiments, the diffusing includes applying a diffusion kernel to the labeled inputs and the unlabeled inputs.

In some example embodiments, the identifying identifies unlabeled inputs that are within a distance threshold of a decision boundary.

Some example embodiments may include monitoring the training based on the labeled inputs to detect a transition point to transition from training the neural network based on the labeled inputs to training the neural network based on the labeled subset, and automatically transitioning at the transition point from training the neural network based on the labeled inputs to training the neural network based on the labeled subset.

In some example embodiments, the identifying of the refinement subset may include assigning a value for each label and ranking each unlabeled input according to the value for each label, and the identifying may involve identifying the unlabeled inputs based upon the ranking.

In some example embodiments, the labeled inputs of the training data set may include at least three labels that respectively identify one of at least three classifications, and the identifying may identify the unlabeled inputs of the pool data set that have a probability of classification that is below a probability threshold for each of the at least three classifications as the refinement subset.

In some example embodiments, the submitting may include sending the refinement subset to a human labeling group and generating the labeled subset by associating each one of the unlabeled inputs of the refinement subset with at least one label selected by the human labeling group.

In some example embodiments, the submitting may include providing a basis for including each one of the unlabeled inputs in the refinement subset.

In some example embodiments, the training based on the labeled subset may include generating a partially trained neural network and further training the partially trained neural network based on the labeled subset. In some example embodiments, the further training may include training the neural network based on both the labeled subset and the labeled inputs of the training data set. In some example embodiments, the further training may include adding the labeled subset as a mini-batch to a mini-batch training set including the labeled inputs.

In some example embodiments, the training based on the labeled subset may include producing a second training data set including the labeled inputs and the labeled subset; and training a second neural network based on the second training data set.

Some example embodiments may include identifying a second refinement subset of the unlabeled inputs of the pool data set and submitting the second refinement subset of the unlabeled inputs to a labeling process to produce a second labeled subset, wherein the training based on the labeled subset includes training the neural network based on both the labeled subset and the second labeled subset.

In some example embodiments, the training data set is a video sequence of video frames that depict events that are identified by the labeled inputs, and the classifying identifies events that are depicted by video frames of a new video sequence.

Some example embodiments may include apparatuses that classify data, including a memory storing a pool data set including unlabeled inputs and processing circuitry configured to identify a refinement subset of the unlabeled inputs of the pool data set by determining, for each unlabeled input of the pool data set, a distance of the unlabeled input to other unlabeled inputs of the pool data set, submit the refinement subset to a labeling process to produce a labeled subset, train the neural network based on the labeled subset to produce a trained neural network, and classify new data using the trained neural network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

At least some example embodiments will become more fully understood from the detailed description provided below and the accompanying drawings, wherein like elements are represented by like reference numerals, which are given by way of illustration only and thus are not limiting of example embodiments and wherein:

FIG. 1 is a diagram of an apparatus according to some example embodiments.

FIG. 2 is a diagram illustrating an example neural network that may be processed by an apparatus according to some example embodiments.

FIG. 3 is a diagram illustrating a feature space of an output of a neural network.

FIG. 4 is a diagram illustrating an active learning technique for a deep neural network.

FIG. 5 is a diagram illustrating a feature space of an output of a neural network in accordance with some example embodiments.

FIG. 6 is a diagram illustrating another active learning technique for a deep neural network in accordance with some example embodiments.

FIG. 7 is a diagram illustrating a proximity graph produced from a last hidden layer output of a last hidden layer of a neural network in accordance with some example embodiments.

FIG. 8 is a diagram illustrating another proximity graph produced from a last hidden layer output of a last hidden layer of a neural network in accordance with some example embodiments.

FIG. 9 is a diagram illustrating a diffusion process to diffuse labels from labeled input to unlabeled inputs based on a proximity graph in accordance with some example embodiments.

FIG. 10 is a pseudocode block for a diffusion process to diffuse labels from labeled input to unlabeled inputs based on a proximity graph in accordance with some example embodiments.

FIG. 11 is a set of data demonstrating some features of some example embodiments.

FIG. 12 is another set of data demonstrating some features of some example embodiments.

FIG. 13 is an example method of classifying data according to some example embodiments.

FIG. 14 is another example method of classifying data according to some example embodiments.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing at least some example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments are discussed herein as being implemented in a suitable computing environment. Although not required, example embodiments will be described in the context of computer-executable instructions (e.g., program code), such as program modules or functional processes, being executed by one or more computer processors or CPUs. Generally, program modules or functional processes include routines, programs, objects, components, data structures, etc. that performs particular tasks or implement particular abstract data types.

In the following description, example embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

### I. Apparatus

FIG. 1 is a diagram of an apparatus 102 according to some example embodiments.

As shown in FIG. 1, the apparatus 102 includes processing circuitry 116 that is configured to implement a neural network 106. In some example embodiments, the processing circuitry 116 may include hardware such as logic circuits; a hardware/software combination, such as a processor executing software; or a combination thereof. For example, a processor may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry 116 may implement the neural network 106 in a variety of ways. As a first such example, the processing circuitry 116 may be or may include a processor that is configured to execute a set of instructions that transform the processor into a special-purpose processor as an example embodiment of the present disclosure, and that transform a computer into a special-purpose computer as an example embodiment of the present disclosure. As a second such example, the processing circuitry 116 may be or may include circuitry that is designed and manufactured to implement a neural network.

The neural network 106 may include, for example, a set of neurons arranged as a sequence of layers, such as an input layer, one or more hidden layers, and an output layer. The neural network 106 may be organized according to various neural network models, such as a multilayer perceptron (MLP) model, a radial basis function (RBF) neural network, a convolutional neural network (CNN) model, a recurrent neural network (RNN) model, a deconvolutional network (DN) model, a deep belief network (DBN) model, a residual neural network (ResNet) model, a support vector machine (SVM) neural network model, and the like. In some example embodiments, the neural network 106 may include a hybrid of neural subnetworks of different types, such as a convolutional recurrent neural network (CRNN) model and/or generative adversarial networks (GANs), and/or an ensemble of two or more neural subnetworks of the same or different types, optionally including other types of learning models. The neural network 106 may be organized according to a set of hyperparameters, for example, the number of layers, the number of neurons in each layer, the types of layers (e.g., a fully connected layer, a convolutional layer, a max or average pooling layer, and a filter concatenation layer), the operating characteristics of each layer (e.g., a size or count of a filter of a convolutional layer, a padding size, a stride, and/or an activation function to be utilized to generate the output of the layer), and/or the inclusion of additional features (e.g., a long short term memory (LSTM) unit, a gated recurrence unit (GRU), and/or a skip connection). The input layer of the neural network 106 may include a number of neurons according to a dimensionality of an input. Similarly, the output layer of the neural network may include a number of neurons according to a dimensionality of an output. The memory 104 may store, for the neural network 106, a set of parameters, such as a weight of a connection between a neuron in a fully-connected layer and each neuron in a preceding layer of the neural network. In various types of deep neural networks, the number of layers and/or the number of neurons in each layer may be large. The present disclosure is not limited to these examples of neural networks, and may include neural networks of different types and/or organizational structures than the example embodiments discussed herein.

The memory 104 of the apparatus 102 stores a training data set 108 including a set of labeled inputs that may be provided to train the neural network 106, that is, inputs that are associated with a correct, desired, and/or anticipated output that the neural network 106 is to produce. For example, if the neural network 106 is configured to classify each input into one of two or more classes, then each input of the training data set 108 may include a label indicating the class into which the neural network 106 is to classify the input. The apparatus 102 stores a pool data set 110 of unlabeled inputs that are not yet associated with a label. In some example scenarios, the training data set 108 may be locally stored by the apparatus 102. In other example scenarios, the training data set 108 and/or the pool data set 110 may be remote to the apparatus 102, such as stored by a remote database server, and the apparatus 102 may access the training data set 108 and/or the pool data set 110 to train the neural network 106. In still other example scenarios, the training data set 108 and/or the pool data set 110 may be provided to the apparatus 102 as live data, for example, data received from a sensor such as a camera.

In some example embodiments, the memory 104 of the apparatus 102 stores instructions that encode a training process 112, which, when executed by a processor of the processing circuitry 116, cause the processing circuitry 116 of the apparatus 102 to process the training data set 108 and/or the pool data set 110 with the neural network 106 to produce a trained neural network. The processing circuitry 116 may execute the training process 112, for example, a supervised training model, an unsupervised training model, and/or a reinforcement training model. The processing circuitry 116 may be configured to execute a training process 112 that may include a number of variations, for example, a mini-batch size, a number of epochs to be executed, a loss function, forms of normalization and/or regularization that may be applied during the training, and/or performance metrics that may be used to evaluate and validate the performance of the neural network 106. In some example embodiments, the processing circuitry 116 may include specialized hardware for implementing some aspects of the neural network 106, such as a graphics processing unit (GPU) and/or a tensor processing unit (TPU). In some other example embodiments, the processing circuitry 116 may be configured to execute a training process 112 may be distributed over a collection of computing devices, such as a cloud-based machine learning platform that performs the training using a set of servers including the apparatus 102.

The memory 104 of the apparatus 102 stores instructions that encode a classification process 114, which, when executed by a processor of processing circuitry 116, cause the processing circuitry 116 to classify new data using the neural network 106 after training by providing new data as an input of the neural network 106 and utilizing the output of the neural network 106, for example, as a classification of the input into one of at least two classes. The present disclosure is not limited to processing circuitry 116 that is configured to execute these forms of training and/or applying a neural network 106, and may include processing circuitry 116 that is configured to execute other forms of training and/or applications of neural networks 106 than are featured in the example embodiments discussed herein.

### II. Neural Network Training and Classification

FIG. 2 is a diagram illustrating an example neural network that may be implemented by the processing circuitry 116 of an apparatus according to some example embodiments.

As shown in FIG. 2, the processing circuitry 116 is configured to implement a neural network 106 that is organized as a set of neurons 202 that are arranged in layers, where each neuron 202 of each layer has a connection 204 with each and every neuron 202 of a preceding layer of the neural network 106. Each connection 204 has a weight, for example, a floating-point value that indicates a magnitude of the output of the neuron 202 of the preceding layer that is received by the neuron 202 of the following layer. The layers of the neural network 106 include an input layer 206, a set of hidden layers 208, and an output layer 210. The processing circuitry 116 may be configured to receive an input 212 and to provide the input 212 to the input layer 206 of the neural network 106. The input 212 may have a variable dimensionality, and in some example embodiments, the dimensionality of the input 212 may match the number of neurons 202 in the input layer 206. The processing circuitry 116 may be configured to produce output for each neuron 202 of the input layer 206, optionally by invoking an activation function based on the input 212 to the neuron 202. The processing circuitry 116 may be configured to provide, as input to each neuron 202 of the first hidden layer 208, the output from each of the neurons 202 of the input layer 206, wherein each output is altered by the weight of the connection 204 between the neuron 202 of the hidden layer 208 and the neuron 202 of the input layer 206. The processing circuitry 116 may be configured to generate, for each neuron 202 of the hidden layer 208, a weighted sum of the weighted inputs from the input layer 206 and, optionally, to invoke an activation function based on the weighted sum to produce an output that is received by the neurons of the next hidden layer 208, and so on. In this manner, the processing circuitry 116 may be configured to propagate the input 212 through the layers of the neural network 106, eventually reaching the output layer 210. The processing circuitry 116 may be configured to provide, to each neuron 202 of the output layer 210, a weighted sum from the last hidden layer 208, optionally by invoking an activation function on the weighted sum, and to produce output 214 from the output layer 210. As an example, if the neural network 106 is used for classification among three classes, the processing circuitry 1176 may be configured to produce output of each of the neurons 202 of the output layer 210, where the output indicates whether the input 212 belongs to one of the classes. The processing circuitry 116 may be configured to interpret the output 214 for an input 212 by identifying which of the neurons 202 of the output layer 210 provides a larger output than any other neuron 202 of the output layer 210.

In some example embodiments, the processing circuitry 116 may be configured to store the weights of a neural network 106 in a memory 104 of the apparatus 102, along with the training data set 108 including a number of inputs that are associated with labels 216 and a pool data set 110 including a number of unlabeled inputs 218-1 through 218-9 (collectively, 218) that are not (at least initially) associated with labels 216. The processing circuitry 116 may be configured to access a labeling process 220, for example, a service that may determine a label 216 that is to be associated with an unlabeled input 218. In some example scenarios, the labeling process 220 may be, for example, another machine learning service or model that identifies labels 216 for unlabeled inputs 218 of the pool data set 110. In some example scenarios, the labeling process 220 may be, for example, a user interface that presents unlabeled inputs 218 to one or more individuals and receives, from the one or more individuals, a label 216 for an unlabeled input 218. The apparatus 102 may invoke the labeling process 220 for one or more of the unlabeled inputs 218 of the pool data set 110, and, based upon receiving a label 216 from the labeling process 220 for the unlabeled input 218, may associate the label 216 with the formerly unlabeled input 218 to expand the number of labeled inputs 212 of the training data set 108.

The apparatus 102 includes processing circuitry 116 that is configured to execute instructions of a training process 112 that cause the processing circuitry 116 to train the neural network 106 using the training data set 108. The processing circuitry 116 is configured to execute instructions of a classification process 114 that causes the processing circuitry 116 to utilize the trained neural network 106 to classify new data 222. For example, when new data 222 is available to the apparatus 102 that may not be associated with a label 216, the processing circuitry 116 may be configured to provide the new data 222 as input 212 to the neural network 106 and to provide the output 214 as a label 216 to be associated with the new data 222, for example, a classification of the new data 222 selected from a set of classes.

FIG. 3 is a diagram illustrating a feature space of an output of a neural network 106 for a set of labeled inputs 212 and unlabeled inputs 218.

As shown in FIG. 3, a feature space 302 is presented as a two-dimensional representation of two features 304-1, 304-2. For example, a layer of a neural network 106 may include two neurons, each of which provides a numeric output that indicates one feature of the output of the layer based on the input 212. Processing circuitry 116 of an apparatus 102 may be configured to utilize the output from an output layer 210 of the neural network 106 or from another layer, such as a hidden layer 208 of the neural network 106. A width of the feature space 302 may represent a spatial arrangement of values for a first feature 304-1 along a first feature axis 306-1, such as a horizontal or x-axis, and a height of the feature space 302 may represent a spatial arrangement of values for a second feature 304-2 along a second feature axis 306-2, such as a vertical or y-axis. The processing circuitry 116 may be configured to process each labeled input 212 having a label 216 and each unlabeled input 218 that is not associated with a label 216 by the neural network 106 to determine each of the two features 304-1, 304-2 and to position each labeled input 212 and each unlabeled input 218 within the feature space 302, such as depicted in FIG. 3. It is to be appreciated that this example includes a representation of two-dimensional output, and that other example embodiments may similarly arrange inputs 212 in a feature space 302 of higher dimensionality based on the dimensionality of the output.

The arrangement of the labeled inputs 212 by the processing circuitry 116 may result in a decision boundary 308, wherein all (or at least some) of the labeled inputs 212 having a first label 216, such as a classification of the input into a first class, may be arranged on one side of the decision boundary 308 in the feature space 302, and all (or at least some) of the labeled inputs 212 having a second label 216, such as a classification of the input into a second class, may be arranged on the other side of the decision boundary 308 in the feature space 302. The decision boundary 308 of the neural network 106 is a discriminant between different classes of inputs.

FIG. 4 is a diagram illustrating an active learning technique for a deep neural network.

As shown in FIG. 4, a pool data set 110 may include unlabeled inputs 218, and processing circuitry 116 may be configured to position the unlabeled inputs 218 within the feature space 302, such as shown in FIG. 3. In order to enable the unlabeled inputs 218 of the pool data set 110 to be used to train the neural network 106, the processing circuitry 116 may be configured to produce an unlabeled data set 402 including all of the unlabeled inputs 218, for example, by submitting and to submit all of the unlabeled inputs 218 of the unlabeled data set 402 to a labeling process 220. For example, the processing circuitry 1176 may be configured to submit of the unlabeled inputs 218 to the labeling process 220 and to receive, from the labeling process, labels 216 for the unlabeled inputs 218 based on an identification of a decision boundary 308 produced during the initial training of the neural network 106 and the position of each unlabeled input 218 in the feature space 302 relative to the decision boundary 308. Alternatively or additionally, the labeling process 220 may include a collection of individuals who may evaluate the unlabeled inputs 218 and select labels 216 based on the content of each unlabeled input 218. The processing circuitry 116 may be configured to execute a labeling process 220 to produce a labeled input set 404, and to perform a retraining 406 of the neural network 106, for example, by reinitializing the neural network 106 and training the neural network 106 anew based on the labeled inputs 212 and the labeled input set 404 including the initially unlabeled inputs 218. In this manner, the processing circuitry 116 may be configured to utilize an active learning technique to produce a trained neural network 408 based on training that includes both the labeled inputs 212 of the training data set and the unlabeled inputs 218 of the pool data set 110.

However, the configuration of the processing circuitry 116 to perform an active learning technique over all of the unlabeled inputs 218 may exhibit some notable properties. As a first example, such an active learning technique may involve an extended retraining 406 due to the volume of unlabeled inputs 218, as well as the retraining 406 of the neural network 106 anew. As a second example, such an active learning technique may involve a high resource cost in submitting the entire unlabeled data set 402 to the labeling process 220, such as an extended utilization of the processing circuitry 116. For example, if the pool data set 110 includes a large number of unlabeled inputs 218, the configuration of the processing circuitry 116 to execute the labeling process 220 may take an extended period of time to determine labels 216 for all of the unlabeled inputs 218. Further, in some example scenarios, several of the unlabeled inputs 218 may have similar output 214, that is, may be close together in the feature space 302. It may therefore be redundant and/or inefficient to configure to the processing circuitry 116 to submit several similar unlabeled inputs 218 to a labeling process 220, which may result in a selection of the same label 216 for several such unlabeled inputs 218 in a manner that may not significantly improve the informative value of the labeled input set 404. As a third example, configuring the processing circuitry 116 to retrain 406 the neural network 106 anew based on the labeled input set 404, such as reinitializing the neural network 106 for the retraining 406, may cause the processing circuitry 116 to fail to utilize progress in partially training the neural network 106 on the labeled inputs 212. That is, causing the processing circuitry 116 to retrain 406 the neural network 106 over the labeled inputs 212 (as well as the unlabeled inputs 218) may be redundant; that is, an extensive process of retraining 406 the neural network 106 by the processing circuitry 116 may result in a selection of parameters for the trained neural network 408 that is similar to those of the partially trained neural network 106. Such redundancy may be costly in terms of extended training time, delays in the production of a trained neural network 410, and/or heightened consumption of computational resources such as processor capacity, storage capacity, network capacity, and/or energy usage.

### III. Active Deep Learning with Refinement Subset

In some example scenarios, the unlabeled inputs 218 may be included in the training of a neural network 106 by determining labels for the unlabeled inputs 218. However, the submission of the unlabeled inputs 218 to a labeling process 220 may be expensive. The determination of a refinement subset of unlabeled inputs 218 to be submitted to the labeling process 220 for labeling may be based on a selection of unlabeled inputs 218 that may be informative, for example, those that may be between labeled inputs 212 with different labels 216 and/or having a low or indeterminate probability of belonging to any of several classes with which the labels 216 are associated. Such unlabeled inputs 218 may represent a point near a decision boundary, where the determination of label 216 may be inconclusive. The selection of such unlabeled inputs 218 may be based on a diffusion process, by which the labels 216 of the labeled inputs 212 diffuse to unlabeled inputs 218 based on the distances between such inputs, which may be determined, for example, by a proximity graph. The diffusion process may cause labels 216 of labeled inputs 212 to be attributed to nearby unlabeled inputs 218, for example, based on the distances therebetween, and subsequently from those unlabeled inputs 218 to other unlabeled inputs 218. Further, the diffusion of different labels 216 to a particular unlabeled input 218 may be considered in a competitive or offsetting manner, for example, by attributing positive values to a first label 216 and negative values to a second label 216. Diffusion of both labels 216 to a particular unlabeled input 218, based upon the distance of a source of each label 216 (e.g., a labeled input 212 or another unlabeled input 218) and the value (that is, the posterior probability) of the label 216 for the source, may result in the labeling of the unlabeled input 218 based upon a sum of the positive value(s) and negative value(s) of the labels diffused from other inputs. A sum with a large magnitude may connote a high-probability (e.g., high-confidence) classification of the unlabeled input 218 for a particular class, while a sum with a small magnitude (e.g., at or near zero) may connote a low-probability (e.g., low-confidence) classification of the unlabeled input 218 for any particular class. The selection of the latter (e.g., low-probability and/or low-confidence) unlabeled inputs 218 as the refinement subset for labeling by the labeling process 200, rather than selecting unlabeled inputs 218 that exhibit a relatively high probability of belonging to a particular class (e.g., having a large positive or large negative value), may facilitate the training of the neural network 220.

FIG. 5 is a diagram illustrating a feature space of an output of a neural network in accordance with some example embodiments.

As shown in FIG. 5, processing circuitry 116 of an apparatus 102 may be configured to position a training data set 108 and a pool data set 110 within a two-dimensional feature space 302 according to a first feature 304-1 and a second feature 304-2 that are spatially represented, respectively, by a first feature axis 306-1 and a second feature axis 306-2. The processing circuitry 116 may be configured to select the position of each labeled input 212 and unlabeled input 214 according to the features 304-1, 304-2 of each input from a layer of a neural network 106, and/or to evaluate the unlabeled inputs 218 within the feature space 302. The processing circuitry 116 may be configured to determine a first distance 502, for example, as a distance between the unlabeled input 218 of the pool data set 110 and one or more labeled inputs 212 of the training data set 108. The processing circuitry 116 may be configured to determine a second distance 504, for example, as a distance between the unlabeled input 218 and other unlabeled inputs 218 of the pool data set 110. For convenience, the first distances 502 and the labeled inputs 212 are illustrated using solid lines and the second distances 504 and the unlabeled inputs 218 are illustrated using dashed lines.

FIG. 6 is a diagram illustrating another active learning technique for a deep neural network in accordance with some example embodiments.

As shown in FIG. 6, the processing circuitry 116 of an apparatus 102 may be configured to identify a refinement subset 602 of the unlabeled inputs 218 of the pool data set 110 based on the determination of the first distances 502 of the unlabeled inputs 218 and the second distances 504. For example, the processing circuitry 116 may be configured to identify the unlabeled inputs 218 to be included in the refinement subset 602 based on a number of properties with respect to the feature space 302. As a first such example, the processing circuitry 116 may be configured to identify the refinement subset 602 as the unlabeled inputs 218 that are distant within the feature space 302 from the labeled inputs 212 (for example, unlabeled inputs 218 having a first distance 502 that is above a distance threshold). The processing circuitry 116 may be configured to include such unlabeled inputs 218 in the refinement subset 602, for example, due to substantial dissimilarity between the unlabeled input 218 and the labeled inputs 212. As a second such example, the processing circuitry 116 may be configured to identify the refinement subset 602 as the unlabeled inputs 218 that are distant within the feature space 302 from the other unlabeled inputs 2108 (for example, unlabeled inputs 218 having a second distance 504 that is above a distance threshold). The processing circuitry 116 may be configured to include the unlabeled inputs 218 in the refinement subset 602, for example, as reducing or avoiding a redundancy of labeling unlabeled input 218 that are similar to other unlabeled inputs 218 of the pool data set 110. As a third such example, the processing circuitry 116 may be configured to identify the refinement subset 602 as the unlabeled inputs 218 that are close within the feature space 302 to the decision boundary 308 (for example, unlabeled inputs 218 having a distance to the decision boundary 308 that is below a distance threshold). The processing circuitry 116 may be configured to include such unlabeled inputs 218 in the refinement subset 602, for example, as representing borderline inputs 212 for which labeling may clarify, verify, and/or provide additional resolution and/or contour to the decision boundary 308.

In some example embodiments, diffusing the labeled inputs 212 of the training data set 108 to the unlabeled inputs 208 may include assigning a value for each unlabeled input 208 and ranking each unlabeled input 208 according to the values of the unlabeled inputs 208 (e.g., rather than selecting the unlabeled inputs 208 that are within a distance threshold). The identifying of the refinement subset 602 may include identifying the unlabeled inputs 208 based upon the ranking, for example, selecting a top (n)-ranked unlabeled inputs 208 as the refinement subset 602. For example, the refinement subset 602 may be identified by ranking the unlabeled inputs 218 based on the smallest absolute values as determined by a label diffusion process, such as shown in FIG. 9, and selecting the top ten unlabeled inputs 218 as the refinement subset 602.

In some example embodiments, the processing circuitry 116 may be configured to submit the refinement subset 602 to a labeling process 220 and to receive, in return, a labeled subset 604. The processing circuitry 118 may be configured to perform further training 408 of a partially trained neural network 606 based on the labeled subset 604, optionally with the labeled inputs 212. The processing circuitry 116 may be configured to perform the further training 408 to produce a trained neural network 410 that may be used to classify new data.

FIG. 6 shows some properties of an active learning technique. As a first example, the processing circuitry 116 may be configured to identify a refinement subset 602, rather than the unlabeled data set 402, as a reduced number of unlabeled inputs 218, which may enable the processing circuitry 116 to perform the labeling process 220 to determine labels 216 faster and/or at a lower resource cost than for the larger and possibly redundant unlabeled data set 402. As a second example, the processing circuitry 116 may be configured to perform the further training 408 of the partially trained neural network 606 using the labeled subset 604 as an extension of the progress achieved by the initial training of the partially trained neural network 606. That is, the labeled subset 604 produced from the refinement subset 602 may enable the processing circuitry 116 to perform an efficient process of refining the partially trained neural network 606, that is, a resumption or continuation of the initial training, rather than discarding the initial training and restarting with an initialized neural network 106. Thus, FIG. 6 illustrates a gain of efficiency in the production of the trained neural network 410 by the processing circuitry 116 based on an identification of the unlabeled inputs 218 that may accelerate the training of the neural network 106 to convergence, which may result in training the neural network 106 faster and/or at a lower consumption of computational resources such as processing capacity, storage capacity, network capacity, and/or energy usage.

To recap, FIG. 6 shows an identifying by the processing circuitry 116 of a refinement subset 602 of unlabeled inputs 218 of the pool data set 110 by determining, for each unlabeled input 218 of the unlabeled inputs 218, a first distance 502 of the unlabeled input 218 to the labeled inputs 212 of the training data set 108 and a second distance 504 of the unlabeled input 218 to other unlabeled inputs 218 of the pool data set 110; a submitting of the refinement subset 602 by the processing circuitry 116 to a labeling process 220 to produce a labeled subset 604; and a training of the neural network 106 by the processing circuitry 116 based on the labeled subset 604 to produce a trained neural network 410, wherein the trained neural network 410 may be used to classify new data 222. In some example embodiments, an apparatus 102 might not initially include a training data set 108 of inputs that are associated with labels 216, but may include pool data 110 including a set of unlabeled inputs 218. Processing circuitry 116 of an apparatus 102 may be configured to train the neural network 106 using soft labels that are generated by a semi-supervised model. For example, the processing circuitry 116 may be configured to generate a proximity graph of the unlabeled inputs 218, and to determine unlabeled inputs 218 that may be representative of different clusters of unlabeled inputs 218 in the features space 302 and/or that may be located near a decision boundary 308 that may exist between clusters of unlabeled inputs 218 in the feature space 302 to generate a refinement subset 602. The processing circuitry 116 may be configured to provide a user interface for a labeling process 220, to receive a labeled subset 604 from the labeling process 220, and to perform training on the neural network 106 using the labeled subset 604 to generate a trained neural network 410. In some example embodiments, the processing circuitry 116 may be configured to perform multiple iterations, for example, by generating a second proximity graph based on the labeled subset 604 and the remaining unlabeled inputs 218 of the pool data 110, for example, based on a label diffusion process involving the labels 216 of the labeled subset 604; generating a second labeled subset 604; and further training 608 the partially trained neural network 606 using the second labeled subset 604 to produce a trained neural network 410. That is, an apparatus may classify data by including a memory storing a pool data set including unlabeled inputs and processing circuitry configured to identify a refinement subset 602 of the unlabeled inputs 208 of the pool data set 110 by determining, for each unlabeled input 208 of the pool data set, a distance of the unlabeled input 208 to other unlabeled inputs of the pool data set 110, submit the refinement subset 602 to a labeling process 220 to produce a labeled subset 604, train the neural network 106 based on the labeled subset 604 to produce a trained neural network 410, and classify new data using the trained neural network 410.

### IV. Proximity Graphs and Label Diffusion

FIG. 7 is a diagram illustrating a proximity graph produced by processing circuitry 116 based on a last hidden layer output of a last hidden layer of a neural network in accordance with some example embodiments.

As shown in FIG. 7, a training set 108 includes one or more labeled inputs 212 and one or more unlabeled inputs 218. Processing circuitry 116 may be configured to provide each labeled input 212 of the training data set 108 as input to a neural network 106 including an input layer 206, one or more hidden layers 208, and an output layer 210 that produces an output 214. The processing circuitry 116 may be configured to generate an output for each neuron 202 of each hidden layer 208 and the output layer 210, for example, as a weighted sum over the inputs of the preceding layer and by processing the weighted sum with an activation function, and to provide the output of the activation function as input to a succeeding layer in the neural network 106 or, in the case of the output layer 210, as part of an output 214 for the input.

The processing circuitry 116 may be configured to produce, for each neuron 202 of a last hidden layer 702 of the hidden layers 208, a last hidden layer output 704. In addition to providing the last hidden layer output 704 as input to the neurons 202 of the output layer 210, the processing circuitry 116 may be configured to use the last hidden layer outputs 704 of the last hidden layer 702 to form a proximity graph 706 of the labeled inputs 212 of the training data set 108 and the unlabeled inputs 218 of the pool data set 110. That is, the processing circuitry may use the last hidden layer outputs 704, which may represent high-level features of each processed input that contribute to the outputs 214 and the decision boundary 308 formed thereby, as a source of information about similarities among each of the labeled inputs 212 of the training data set 108 and each of the unlabeled inputs 218 of the pool data set 110.

FIG. 8 is a diagram illustrating another proximity graph produced by processing circuitry 116 from a last hidden layer output of a last hidden layer of a neural network in accordance with some example embodiments.

As shown in FIG. 8, processing circuitry 116 may be configured to determine, based on the output 704 of the last hidden layer 702, a position of each input in a feature space 302 for the training data set 108 and the pool data set 110. For example, the processing circuitry 116 may be configured to provide a labeled input 212 of the training data set 108 or an unlabeled input 212 of the pool data set 110 as input to the neural network 106; to cause each of a first neuron 202 and a second neuron 202 of the last hidden layer 702 to provide an output; and/or to determine, based on the outputs of the first neuron 202 and the second neuron 202 for each labeled input 212 and each unlabeled input 218, a position of each such input along a first feature axis 306-1 and a second feature axis 306-2, respectively, of a spatial arrangement of the feature space 302 of the last hidden layer 702. For example, if the processing circuitry 116 outputs a value between 0.0 and 1.0 for each of the first neuron 202 and the second neuron 202, the first feature axis 306-1 may be horizontally oriented over the range of 0.0 (left) and 1.0 (right), and the second feature axis 306-2 may be vertically oriented over the range of 0.0 (top) and 1.0 (bottom). The set of last hidden layer outputs 704 for each input is shown in tabular form in FIG. 8.

The processing circuitry 116 may be configured to produce a proximity graph 706 that represents a proximity between the neurons 202. In some example embodiments, the processing circuitry 116 may be configured to determine the proximity graph 706 with a high fractional value, such as a value close to 1.0, to indicate neurons 202 in proximity, and a low fractional value, such as a value close to 0.0, to indicate neurons 202 that are distant. The proximity graph 706 in FIG. 8 is determined according to the following equation:

$$w ( i , j ) = exp ( - \frac{\vert h ( {x}_{i} ) - h ( {x}_{j} ) \vert}{{max}_{k ∈ N} \vert h ( {x}_{i} ) - h ( {x}_{k} ) \vert} )$$

wherein i, j are inputs in the training data set 108 or the pool data set 110, h(xᵢ) is a weighted sum for input xᵢ determined as h(xᵢ)=Σᵢxᵢwᵢⱼ where wᵢⱼ is the weight of the connection between (previous layer) neuron i and (current layer) neuron j, and N is the number of inputs in the training data set 108 and the pool data set 110. It is to be appreciated that these mathematical equations are examples that some processing circuitry 116 may utilize to produce for a proximity graph 706, and that some processing circuitry 116 may utilize other mathematical equations to produce a proximity graph 706 in some example embodiments.

As shown in FIG. 9, processing circuitry 116 may be configured to perform a diffusion process to diffuse labels 216 from labeled inputs 212 to unlabeled inputs 218 based on the proximity graph 706 of FIG. 8 in accordance with some example embodiments. FIG. 9 depicts an example of diffusion performed by processing circuitry 116 over a smaller feature space 302 that includes three labeled inputs 212 with two labels 216 (identified as label 1 and label 2). The processing circuitry 116 may be configured to classify the inputs of the training data set 108 and the pool data set 110 according to a decision boundary 308. However, in some cases, the processing circuitry 116 may not be capable of identifying the decision boundary 308 based on a partial training of the neural network 106 and a partially trained neural network 606. Alternatively, the processing circuitry 116 may be configured to identify the decision boundary 308 in an imprecise manner, such as with detail missing as to its location and/or contour, which may affect borderline inputs including initially unlabeled inputs 218.

Processing circuitry 116 may be configured to establish a set of values 906 for the labels 216, such as a value 906 of +1 for the first label 216 and a value 906 of −1 for the second label 216. The processing circuitry 116 may be configured to initially assign each labeled input 212 a first value 906-1 according to its label 216, and to assign to each unlabeled input 218 a value of 0.0.

In some example embodiments, the processing circuitry 116 may be configured to initialize the value of each unlabeled input 218 to begin the diffusion process with another value, such as an initial probability of each unlabeled input 218 having a particular label 216. For example, one or more of the unlabeled input 218 may be initially evaluated by a classifier to determine (e.g., preliminarily) a label 216 that may be assigned to the unlabeled input 218, for example, by a partially trained neural network 606. While the classifier may not be capable of determining the labels 216 of the unlabeled inputs 218 with high confidence (e.g., with a lower confidence than labels 216 selected by the labeling process 220), the classifier may be capable of producing a probability or estimate that the unlabeled input 218 is associated with and/or identified by a particular label 216. The processing circuitry 116 may be configured to assign the probability of the unlabeled input 218 associated with a label 216 (e.g., a floating-point value between 0.0 and 1.0 for a first label 216, and a floating-point value between 0.0 and −1.0 for a second label 216, representing a probability multiplied by −1.0) as the initial value 906 of the unlabeled input 218 to begin the diffusion process. As an example, the classifier may determine a probability of the unlabeled input 218 for the first label 216 (as a positive value) and the second label 216 (as a positive value multiplied by −1.0), and to assign, as the value for the unlabeled input 218, the sum of the probabilities. For a multiclassification scenario, the processing circuitry 116 may be configured to choose the value for each unlabeled input 218 in various ways, for example, as the difference between the probability of the label with the highest probability and the probability of the label with the second-highest probability.

In a first diffusion 908-1 of FIG. 9, the processing circuitry 116 may be configured to diffuse the labels 216 from the labeled inputs 212 to unlabeled inputs 218 that are proximate to the labeled inputs 212 according to the proximity graph 706. That is, the processing circuitry 116 may be configured to diffuse the values 906 of the labels 216 from the labeled inputs 212 to the closest unlabeled inputs 218 in the feature space 302, such that the label 216 for the first labeled input 212 is diffused to the fourth unlabeled input 218; the label 216 for the second labeled input 212 is diffused to the fifth unlabeled input 218; and the label 216 for the third labeled input 212 is diffused to the sixth unlabeled input 218. The processing circuitry 116 may be configured to cause, by executing the diffusion. each unlabeled input 218 to receive the value 906 of the label 216 of the labeled input 212 multiplied by the value in the proximity graph 706 from the labeled input 212 to the unlabeled input. For example, the processing circuitry 116 may be configured to cause the first unlabeled input 218 to receive a value of +1.0 (the value 906 of the label 216 of the first labeled input 212) multiplied by 0.82 (the proximity graph value from the first labeled input 212 to the fourth unlabeled input 218). The processing circuitry 116 may be configured to add the resulting value of +0.82 to the current value 906 for the fourth unlabeled input 218 (0.0). Similarly, the processing circuitry 116 may be configured to cause the sixth unlabeled input 218 to receive a value of −1.0 (the value 906 of the label 216 of the third labeled input 212) multiplied by 0.67 (the proximity graph value from the third labeled input 212 to the sixth unlabeled input 218). The processing circuitry 116 may be configured to add the resulting value of −0.67 to the current value 906 for the sixth unlabeled input 218 (0.0), thereby producing a second value 908-2 for each of the unlabeled inputs 218.

In a second diffusion 908-2 of FIG. 9, the processing circuitry 116 may be configured to diffuse the values that were previously diffused to the unlabeled inputs 218 onward to other unlabeled inputs 218 based on the proximity graph. The processing circuitry 116 may be configured to add the values of the incoming labels for each unlabeled input 218, multiplied by the respective values in the proximity graph 706, to produce a new value 906. The processing circuitry 116 may be configured to produce values 906 for the labeled inputs 212 that are an aggregate of the values 906 of the labels 216 received directly via diffusion from the labeled inputs 212 and indirectly via diffusion through the unlabeled inputs 216. Additionally, the processing circuitry 116 may be configured to cause some unlabeled inputs 218 to receive conflicting values 906 from differently labeled inputs 212, wherein the resulting value 906 may include a difference that reflects the relative proximity of the unlabeled input 218 to several labeled inputs 212 and, optionally, other unlabeled inputs 218, thus producing a second value 908-3 for each of the unlabeled inputs 218.

The processing circuitry 116 may be configured to continue the diffusion of the labels 216, for example, for a set number of diffusion steps, and/or until diffusion reaches an equilibrium. Based on the values 706 resulting from the label diffusion, the processing circuitry 116 may be configured to identify a refinement subset 602. For example, for each unlabeled input 218, the processing circuitry 116 may be configured to generate a weighted sum of the value(s) for each label 216 diffused to the unlabeled input 218; and to include, in the refinement subset 602, the unlabeled inputs 218 having a weighted sum with a minimum or low absolute value 906 (e.g., an absolute value that is below a threshold). In some example embodiments, the processing circuitry 116 may be configured to identify a selected number of the unlabeled inputs 218 having values 906 that are closest to zero, relative to the other unlabeled inputs 218 of the pool data set 110, for inclusion in the refinement subset 602.

Put another way, a neural network 106 may include a sequence of layers including an output layer 210 and a hidden layer 208 connected to the output layer 210, and the processing circuitry 116 may be configured to generate the proximity graph 706 based on similarities of output 214 of each input from the hidden layer 706 of the neural network 106. Additionally, the processing circuitry 116 may be configured to diffuse labels 216 from the labeled inputs 212 to the unlabeled inputs 218 based on the proximity graph 706, where the diffusing for each unlabeled input 218 is based on a first distance 502 of the unlabeled input 218 to each labeled input 212 and a second distance 504 of the unlabeled input 218 to other unlabeled inputs 218 of the pool data set 110. The processing circuitry 116 may be configured to identify the refinement subset 602 by adding unlabeled inputs 218 based on the diffusing.

Some example embodiments that may vary in some respects are now presented.

In some example embodiments, processing circuitry 116 may be configured to determine the feature space 302 for the inputs based not just on the output 704 of the last hidden layer 702, but on the output 704 of one or more other hidden layers 208. For example, the neural network 106 includes a sequence of layers including a last hidden layer 702 connected to the output layer 210 and a second hidden layer 208 connected to the last hidden layer 702 of the neural network 106, and the processing circuitry 116 may be configured to generate the proximity graph based on similarities of the output 704 of each input from the second hidden layer 208 to the last hidden layer 702. In some example embodiments, the processing circuitry 116 may be configured to use a different hidden layer 208 instead of the last hidden layer 702, such as the second hidden layer 208. In some example embodiments, the processing circuitry 116 may be configured to evaluate the output of two or more hidden layers 208, which may enable a selection of one of the hidden layers 208 to use for the feature space 302.

In some additional example embodiments, the processing circuitry may be configured to apply diffusion over a set of hidden layers 208 and to identify the refinement subset based on a sum calculated over the set of hidden layers 208. For example, the neural network 106 may include multiple (e.g., at least two) hidden layers that are interconnected (e.g., each hidden layer may be mutually connected with a preceding hidden layer and/or a next hidden layer in the sequence of layers). For each hidden layer 208, the processing circuitry 116 may be configured to generate a hidden layer proximity graph for the labeled inputs of the training data set 108 and the pool data set 110 based on similarities in the output of the hidden layer. For each hidden layer, the processing circuitry 116 may be configured to identify a value for each unlabeled input of the pool data set 110 based on the hidden layer proximity graphs. The processing circuitry 116 may be configured to identify the refinement subset, for example, as the unlabeled inputs of the pool data set that have a minimum weighted sum as compared with other unlabeled inputs of the pool data set.

In some example embodiments, processing circuitry 116 may be configured to apply the diffusing by applying a diffusion kernel to the labeled inputs 212 and the unlabeled inputs 218. For example, the processing circuitry 116 may be configured to produce a diffusion kernel, K, by dividing each row of a proximity graph 706 by the weighted sum of the entries of the row. The processing circuitry 116 may be configured to use the diffusion kernel, K, to diffuse the labels 216 of the training data set 108 by applying the kernel to a vector of the size of the training data set 108 that includes the values 906 of the labels 216, such as +1.0 for a first label 216 and −1.0 for a second label 216. The processing circuitry 116 may be configured to repeat the diffusion a selected number of times.

FIG. 10 is a pseudocode block 1000 of an algorithm that may be executed by processing circuitry 116 as a diffusion process to diffuse labels 216 from labeled input 212 to unlabeled inputs 218 based on a proximity graph 706 in accordance with some example embodiments. Processing circuitry 116 may be configured to follow the algorithm represented by the pseudocode block with selecting, for the refinement subset 602, the unlabeled inputs 218 having a minimal absolute value 906. It is to be appreciated that the algorithm indicated by the pseudocode block 1000 is but one such algorithm that may be executed by processing circuitry 116 to perform diffusion in accordance with some example embodiments, and that other diffusion processes may be executed by processing circuitry 116 in other example embodiments that vary with respect to the pseudocode block as shown in FIG. 10.

In some example embodiments, diffusing the labeled inputs 212 of the training data set 108 to the unlabeled inputs 208 may include assigning a value for each unlabeled input 208 and ranking each unlabeled input 208 according to the values of the unlabeled inputs 208. The identifying of the refinement subset 602 may include identifying the unlabeled inputs 208 based upon the ranking, for example, selecting a top (n)-ranked unlabeled inputs 208 as the refinement subset 602. As another example, the processing circuitry 116 may be configured to perform the ranking based on other factors in addition to the values of the unlabeled inputs 208. In some example embodiments, the processing circuitry 116 may be configured to rank the unlabeled inputs 208 primarily by values and secondarily by estimated density. For example, two unlabeled inputs 208 may be assigned values during the diffusion process that are identical (e.g., 0.0) or similar (e.g., 0.00 and 0.01), and the two unlabeled inputs 208 may be further ranked according to estimated density (e.g., selecting for the refinement subset 602 a first unlabeled input 208 that is within a high-density cluster of labeled and/or unlabeled inputs, and not selecting for the refinement subset 602 a second unlabeled input 208 that is an outlier). In other example embodiments, the processing circuitry 116 may be configured to perform the ranking based on both the values and the estimated density of the unlabeled input 216 (e.g., as a weighted sum).

In some example embodiments, the labeled inputs 212 of the training data set 108 may include at least three labels. The processing circuitry 116 may be configured to apply diffusion to such a multiclass classification scenario. For example, if the labeled inputs 212 of the training data set 108 include at least three labels 216 that respectively identify one of at least three classifications, the processing circuitry 116 may be configured to identify the unlabeled inputs 208 that have a probability of classification that is below a probability threshold for each of the at least three classifications as the refinement subset. That is, instead of being configured to determine a weighted sum, the processing circuitry may be configured to perform the diffusion by tracking the probability for which each unlabeled input 218 may be classified into each class based on a label diffusion, and/or to identify the refinement subset 602 as the unlabeled inputs 218 that have a low probability of being classified into any of the classes represented by the labels 216. That is, the processing circuitry 116 may be configured to implement a 1 vs. all classifier for each class, and to form the identification of the refinement subset 602 based on the expression:

$${arg min}_{i} {min}_{c} \vert {p}_{ic} \vert$$

wherein |p_{ic}| is the probability of an input i belonging to a class c based on its value 906. It is to be appreciated that this mathematical expression is but one example that may be executed by processing circuitry 116 for multiclass diffusion involving a proximity graph 706, and that other mathematical expressions may be executed by processing circuitry 116 to diffuse multiple labels over a proximity graph 706 in some example embodiments.

In some example embodiments, the identification of the refinement subset 602 by the processing circuitry 116 may include other criteria. As one example, the processing circuitry may be configured to identify unlabeled inputs 218 for the refinement subset 602 that are within a distance threshold of a decision boundary 308. For example, a partially trained neural network 606 may be executed by the processing circuitry 116 to approximate the decision boundary 308 between labeled inputs 216 of different classes, and to identify unlabeled inputs 218 for inclusion in the refinement subset 602 that are close to the decision boundary 308. The processing circuitry 116 may be configured to perform further training 408 on a labeled subset 604 based on these unlabeled inputs 218, which may cause the processing circuitry 116 to clarify, verify, and/or provide additional resolution and/or contour to the decision boundary 308.

In some example embodiments, the training data set 108 may include inputs 212 with more than two labels 216, such as multiclassification. The processing circuitry 116 may be configured to apply a diffusion process to diffuse the labels 216 over the unlabeled inputs 218, for example, by determining a label value 906 for each of the at least three labels 216, and unlabeled inputs 218 may be selected for the refinement subset 602 based on a minimum difference of the label values 906 for the respective at least three labels 216. The processing circuitry 116 may be further configured to receive, from the labeling process 220, labels 216 for each unlabeled input 218 of the refinement subset 602, wherein the labels 216 are selected from the set of at least three labels, and to perform further training 608 based upon the labeled subset 604 including inputs 212 labeled with each of these at least three labels 216.

### V. Example Data

FIG. 11 is an illustration of a training of a neural network 106 according to a variety of training methodologies.

A first chart 1100 presents an accuracy of a trained neural network based on a selected number of labeled data points to classify a non-separable data set, such as a checkerboard classification pattern. A second chart 1102 presents an accuracy of a trained neural network based on a selected number of labeled data points to classify the MNIST digit recognition data set. As indicated in the first chart 1100 and the second chart 1102, training based on diffusion, such as discussed herein, demonstrated higher rates of accuracy based on a lesser number of labeled data points as compared with neural networks trained by other training methodologies.

FIG. 12 is an illustration of a training of a neural network 106 based on a number of stochastic gradient descent (SGD) iterations.

A first chart 1200 presents an accuracy of a trained neural network using a variable number of SGD iterations to classify a non-separable data set, such as a checkerboard classification pattern. A second chart 1102 presents an accuracy of a trained neural network using a variable number of SGD iterations to classify the MNIST digit recognition data set. As indicated in the first chart 1200 and the second chart 1202, training based on diffusion, such as discussed herein, demonstrated faster training, as reflected by faster rates of accuracy improvement for selected numbers of SGD iterations, as compared with neural networks trained by other training methodologies.

### VI. Training Using Refinement Subset

In some example embodiments, processing circuitry 116 may be configured to include the refinement subset 602 in further training 608 of a partially trained neural network 606. In some other example embodiments, processing circuitry 116 may be configured to use the labeled subset 604 to retrain 406 a neural network 106, which may include reinitializing the neural network 106, for example, by randomizing the weights of the connections 204 between the neurons 204. For example, the processing circuitry 116 may be configured to perform the training based on the labeled subset 606 by producing a second training data set 108 that includes the labeled inputs 212 and the labeled subset 704 and training a second neural network 106 based on the second training data set 108.

In some example embodiments, processing circuitry 116 may be configured to perform the further training 608 and/or retraining 606 based on both the labeled subset 604 and the initially labeled inputs 212 of the training data set 108. As an example, where the neural network 106 is trained based on mini-batches of the training data set 108, the processing circuitry 116 may be configured to add the labeled subset 604 as an additional mini-batch to the mini-batch training set including the labeled inputs 212. In some other example embodiments, processing circuitry 116 may be configured to base the further training 608 and/or retraining 606 on a subset of the labeled subset 604 and a subset of the initially labeled inputs 212 of the training data set 108, for example, a random sampling of the labeled subset 604 and the initially labeled inputs 212. In still other example embodiments, processing circuitry 116 may be configured to execute the further training 608 and/or retraining 606 based only on the labeled subset 604.

In some example embodiments, processing circuitry 116 may be configured to monitor a training of a neural network 106 based on the labeled inputs 212 to detect a transition point to transition from training the neural network 106 based on the labeled inputs 212 to training the neural network 106 based on the labeled subset 218. For example, the processing circuitry 116 may be configured to train the neural network 106 based on the labeled inputs 212 may converge on a partially trained neural network 406, to detect the convergence, and to automatically transition at the transition point from training the neural network 106 based on the labeled inputs 212 to further training 608 the neural network 106 based on the labeled subset 604. Such automatic transitioning may cause the processing circuitry 116 to execute a two-phase training, wherein the processing circuitry 116 is configured to partially train the neural network 106 on the initially labeled inputs 212 (e.g., inputs with a high confidence) and then further train 608 the neural network 106 on the labeled subset 604 based on the refinement subset 602 (e.g., inputs that are borderline and/or outliers) to expand the domain of the feature set over which the trained neural network 408 may be proficient in classifying or otherwise evaluating. As another example, the processing circuitry 116 may be further configured to train the neural network 106 based on the labeled inputs 212, and may detect a failure to converge, which may cause the processing circuitry 116 to automatically transition at the transition point from training the neural network 106 based on the labeled inputs 212 to further training 608 the neural network 106 based on the labeled subset 604, and/or to retraining 406 the neural network 106 based on the labeled subset 604. During further training 608 and/or retraining 406, the processing circuitry 116 may be configured to provide the labeled subset 604 as additional and/or alternative inputs that may clarify ambiguities, such as labeling collisions or conflicts among the labeled inputs 212, and which may promote convergence and the production of a trained neural network 408.

In some example embodiments, the processing circuitry 116 may include, as a labeling process 220, a user interface that presents to a human labeling group an unlabeled input 218 and receives, from the human labeling group, a label 216 for the unlabeled input 218. The processing circuitry 116 may be configured to produce the labeled subset by associating each one of the unlabeled inputs 218 of the refinement subset 402 with at least one label selected by the human labeling group. In some example embodiments, the processing circuitry 116 may be configured to submit the refinement subset 402 to the human labeling group including, for at least one of the unlabeled inputs 218, a basis for including the unlabeled input 218 in the refinement subset 402. As an example, the processing circuitry 116 may include a first unlabeled input 218 in the refinement subset 402 because it is between two labeled inputs 212 with different labels 216, thus resulting in a value 906 that may be very small, and the processing circuitry 116 may be further configured to indicate that the unlabeled input 218 is a borderline case that is near a decision boundary. As another example, the processing circuitry 116 may include a second unlabeled input 218 in the refinement subset 402 because it is far away from both labeled inputs 212 and unlabeled inputs 218, and the processing circuitry 116 may be further configured to represent an unusual and/or outlier for which a label 216 selected by the human labeling group may provide information about a sparsely represented area of the domain of the training data set 108. Configuring the processing circuitry 116 to provide the basis for which an unlabeled input 218 is included in the refinement subset 402 may enable the processing circuitry 116 (for example, the user interface of the processing circuitry 116) to guide and/or inform a human labeling group as to why an unlabeled input 218 is included, for example, why the label 216 for this unlabeled input 218 may promote the training of the neural network 106. As an alternative to a human labeling group, the processing circuitry 116 may be configured to execute and/or access a labeling process 220 including an automated classifier, such as a robust and/or sophisticated image processing platform or interface that may produce accurate labels for unlabeled images, but that may have limited capacity and/or an associated cost.

In some example embodiments, processing circuitry 116 may be configured to perform training of a neural network based on the labeled subset 604 by receiving, from the labeling process 220, an inconclusive labeling of one of the unlabeled inputs 218. For example, the processing circuitry may receive, from the labeling process 220, different and potentially incompatible or mutually exclusive labels 216 for the same unlabeled input 218 (e.g., human labelers may reach different conclusions as to whether an animal is a cat or a dog). As another example, the processing circuitry 116 may include in a refinement subset an unlabeled input 218 that may be a poor fit for any of the classifications that are provided by the labeled inputs 212. In such cases, the processing circuitry 116 may be configured to exclude the unlabeled input 218 from the training based on the labeled subset 604.

In some example embodiments, processing circuitry 116 may be configured to identify, and submit to a labeling process 220, a second refinement subset of unlabeled inputs 218, and to receive, from the labeling process 220, a second labeled subset 604, which the processing circuitry 116 may be configured to include in the further training 608 and/or the retraining 406 of the neural network 106. For example, if the further training 608 and/or retraining 406 does not enable the training of the neural network 106 to converge, the processing circuitry 116 may be configured to select additional unlabeled inputs 218 for the second refinement subset 602 that were not included in the first refinement subset 602. The expansion of the labeled inputs in the training data set 108 in this manner may cause the processing circuitry 116 to provide additional data that enables the neural network 106 to converge.

### VII. Uses of Trained Neural Networks

Processing circuitry 116 may utilize a trained neural network 408 that is produced in accordance with some example embodiments in a variety of ways to classify new data 222. As one such example, the processing circuitry 116 may store or access a training data set as a video sequence of video frames that depict events that are identified by the labeled inputs 212. The processing circuitry 116 may be configured to classify new input, such as video frames of a new video sequence, by identifying events that are depicted in the video frames by implementing, training, and executing a neural network in accordance with the present disclosure.

As one such example, processing circuitry 116 may be configured to train a neural network 108 to identify events that are illustrated within video sequences. For example, the training data set 108 may include labeled inputs 212 including video sequences with labels 216 that indicate the events illustrated within the video sequence. As one such example, a video sequence may depict a traffic intersection, and the labels 216 may indicate that certain frames and/or locations within the video sequence that depict an occurrence of a traffic signal, a pedestrian traversing a crosswalk, an occurrence of a road hazard, and/or a collision between two or more vehicles. The pool data set 110 may include unlabeled inputs 218 including video sequences without labels 216. The evaluation of each unlabeled inputs 218 by a labeling process 220 to identify labels 216 for each unlabeled input 218 may be a comparatively expensive process, for example, may involve a computationally intensive determination of objects appearing in each frame of the video sequence and the comparison of the locations of such objects across frames of the video sequence. The processing circuitry 116 may be configured to identify a refinement subset 602 for evaluation by the labeling process 220 to produce the labeled subset 604 of video sequences with labels 216 that indicate the events arising in the video sequence. The processing circuitry 116 may be configured to perform further training 608 on a partially trained neural network 606 using the video sequences in the labeled subset 604. The processing circuitry 116 may therefore generate a trained neural network 410 and may process new unlabeled inputs 218 (e.g., new video sequences) using the trained neural network to produce the labels 216 that identify the events illustrated within the unlabeled inputs 218. Such selection may enable the generation of the fully trained neural network 410 in a manner that conserves reliance upon the labeling process 220, for example, by applying the labeling process 220 only to a minimum refinement subset 602 that provides maximum value in refining a partially trained neural network 606.

### VIII. Illustrations of Some Example Embodiments

Returning to FIG. 1, some example embodiments may include an apparatus 102 include including a memory 104 storing a training data set 108 including labeled inputs 216 and a pool data set 110 including unlabeled inputs 218 and processing circuitry 116 configured to train a neural network 106 based on the labeled inputs 212 of the training data set 108; identify a refinement subset 602 of the unlabeled inputs 218 of the pool data set 110 by determining, for each unlabeled input 218 of the unlabeled inputs 218, a first distance 502 of the unlabeled input 218 to the labeled inputs 212 of the training data set 108, and a second distance 504 of the unlabeled input 218 to other unlabeled inputs 218 of the pool data set 110; submit the refinement subset 602 to a labeling process 220 to produce a labeled subset 604; train the neural network 106 based on the labeled subset 604 to produce a trained neural network 408; and classify new data 222 using the trained neural network 408.

FIG. 13 is an example method 1300 of classifying data in accordance with some example embodiments. The method 1300 begins at 1302 and includes training 1304, by processing circuitry, a neural network based on labeled inputs of a training data set 108 to produce a partially trained neural network. The method 1300 includes generating 1306, by the processing circuitry, a proximity graph of the labeled inputs of the training data set 108 and unlabeled inputs of the pool data set 110 based on similarities of output from a hidden layer of the neural network for each of the labeled inputs and each of the unlabeled inputs. The method 1300 includes diffusing 1308, by the processing circuitry, labels from the labeled inputs to the unlabeled inputs based on the proximity graph to identify a refinement subset of the unlabeled inputs of the pool data set 110. The method 1300 includes submitting 1310, by the processing circuitry, the refinement subset to a labeling process to produce a labeled subset. FIG. 13 illustrates further training 1312, by the processing circuitry, the partially trained neural network based on the labeled subset to produce a trained neural network. FIG. 13 further depicts classifying 1314, by the processing circuitry, new data using the trained neural network. FIG. 13 ends at 1316.

FIG. 14 is another example method 1400 of classifying data in accordance with some example embodiments. The example method 1400 begins at 1402 and includes training 1404, by processing circuitry, a neural network based on labeled inputs of a training data set; identifying 1406, by the processing circuitry, a refinement subset of unlabeled inputs of a pool data set 110 by determining, for each unlabeled input of the unlabeled inputs, a first distance 502 of the unlabeled input of the pool data set 110 to the labeled inputs of the training data set 108, and a second distance 504 of the unlabeled input to other unlabeled inputs of the pool data set 110; submitting 1408, by the processing circuitry, the refinement subset to a labeling process to produce a labeled subset; training 1410, by the processing circuitry, the neural network based on the labeled subset to produce a trained neural network; and classifying 1412, by the processing circuitry, new data using the trained neural network.

Example embodiments being thus described, it will be obvious that embodiments may be varied in many ways. Such variations are not to be regarded as a departure from example embodiments, and all such modifications are intended to be included within the scope of example embodiments.

1. A method of classifying data, the method comprising:
training, by processing circuitry, a neural network based on labeled inputs of a training data set to produce a partially trained neural network;
generating, by the processing circuitry, a proximity graph of the labeled inputs of the training data set and unlabeled inputs of a pool data set based on similarities of output from a hidden layer of the neural network for each of the labeled inputs and each of the unlabeled inputs;
diffusing, by the processing circuitry, labels from the labeled inputs to the unlabeled inputs based on the proximity graph to identify a refinement subset of the unlabeled inputs of the pool data set;
submitting, by the processing circuitry, the refinement subset to a labeling process to produce a labeled subset;
further training, by the processing circuitry, the partially trained neural network based on the labeled subset to produce a trained neural network; and
classifying, by the processing circuitry, new data using the trained neural network.

2. A method of classifying data, comprising:
training, by processing circuitry, a neural network based on labeled inputs of a training data set;
identifying, by the processing circuitry, a refinement subset of unlabeled inputs of the pool data set by determining, for each unlabeled input of the unlabeled inputs,
a first distance of the unlabeled input to the labeled inputs of the training data set, and
a second distance of the unlabeled input to other unlabeled inputs of the pool data set;
submitting, by the processing circuitry, the refinement subset to a labeling process to produce a labeled subset;
training, by the processing circuitry, the neural network based on the labeled subset to produce a trained neural network; and
classifying, by the processing circuitry, new data using the trained neural network.

3. The method of claim 2, wherein the identifying includes:
generating a proximity graph of the labeled inputs and the unlabeled inputs of the pool data set based on similarities of output from a hidden layer of the neural network for each of the labeled inputs and each of the unlabeled inputs;
diffusing labels from the labeled inputs to the unlabeled inputs based on the proximity graph, wherein the diffusing for each unlabeled input is based on the first distance and the second distance; and
adding unlabeled inputs to the refinement subset based on the diffusing.

4. The method of claim 3, wherein
the neural network includes a sequence of layers including an output layer and a hidden layer connected to the output layer; and
the generating of the proximity graph is based on similarities of output of each input from the hidden layer of the neural network.

5. The method of claim 4, wherein
the sequence of layers further includes a second hidden layer connected to the hidden layer of the neural network; and
the proximity graph is based on similarities of output of each input from the second hidden layer to the hidden layer.

6. The method of claim 3, wherein the diffusing includes:
assigning a value for each label; and
ranking each unlabeled input according to the value for each label; and
wherein the identifying identifies the unlabeled inputs based upon the ranking.

7. The method of claim 3, wherein the diffusing includes:
assigning a value for each label; and
generating a weighted sum of the value for each label diffused to the unlabeled input; and wherein the identifying identifies the unlabeled inputs having a weighted sum with an absolute value that is below a threshold as the refinement subset.

8. The method of claim 7, wherein
the sequence of layers further includes at least two hidden layers that are interconnected; and
the generating of the proximity graph includes a hidden layer proximity graph for each hidden layer of the at least two hidden layers based on similarities of output from the each hidden layer for each input; and
the identifying of the refinement subset includes,
for each unlabeled input, calculating a weighted sum of the value based on the hidden layer proximity graphs of each of the at least two hidden layers, and
identifying the refinement subset as the unlabeled inputs of the pool data set having a minimum weighted sum as compared with other unlabeled inputs of the pool data set.

9. The method of claim 2, wherein the diffusing includes applying a diffusion kernel to the labeled inputs and the unlabeled inputs.

10. The method of claim 2, wherein the identifying identifies unlabeled inputs that are within a distance threshold of a decision boundary.

11. The method of claim 2, further comprising:
monitoring the training based on the labeled inputs to detect a transition point to transition from training the neural network based on the labeled inputs to training the neural network based on the labeled subset; and
automatically transitioning at the transition point from training the neural network based on the labeled inputs to training the neural network based on the labeled subset.

12. The method of claim 2, wherein
the labeled inputs of the training data set include at least three labels that respectively identify one of at least three classifications; and
the identifying identifies the unlabeled inputs that have a probability of classification that is below a probability threshold for each of the at least three classifications as the refinement subset.

13. The method of claim 2, wherein the submitting includes:
sending the refinement subset to a human labeling group; and
generating the labeled subset by associating each one of the unlabeled inputs of the refinement subset with at least one label selected by the human labeling group.

14. The method of claim 13, wherein the submitting includes providing a basis for including each one of the unlabeled inputs in the refinement subset.

15. The method of claim 2, wherein the training based on the labeled subset includes:
generating a partially trained neural network; and
further training the partially trained neural network based on the labeled subset.

16. The method of claim 2, wherein the training based on the labeled subset includes further training the neural network based on both the labeled subset and the labeled inputs of the training data set.

17. The method of claim 16, wherein the further training includes adding the labeled subset as a mini-batch to a mini-batch training set including the labeled inputs.

18. The method of claim 2, wherein the training based on the labeled subset includes:
producing a second training data set including the labeled inputs and the labeled subset; and
training a second neural network based on the second training data set.

19. The method of claim 2, further comprising:
identifying a second refinement subset of the unlabeled inputs of the pool data set; and
submitting the second refinement subset of the unlabeled inputs to the labeling process to produce a second labeled subset; wherein
the training based on the labeled subset includes training the neural network based on both the labeled subset and the second labeled subset.

20. The method of claim 2,
wherein the refinement subset is selected during a first iteration,
the method further comprises: during a second iteration,
identifying a second refinement subset of the unlabeled inputs of the pool data set during the second iteration; and
submitting the second refinement subset of the unlabeled inputs to the labeling process to produce a second labeled subset, and
wherein the training based on the labeled subset includes training the neural network based on both the labeled subset and the second labeled subset.

21. The method of claim 2, wherein
the training data set is a video sequence of video frames that depict events that are identified by the labeled inputs; and
the classifying identifies events that are depicted by video frames of a new video sequence.

22. An apparatus that classifies data, comprising:
a memory storing a pool data set including unlabeled inputs and a training data set including labeled inputs; and
processing circuitry configured to:
train a neural network based on the labeled inputs of the training data set;
identify a refinement subset of the unlabeled inputs of the pool data set by determining, for each unlabeled input of the unlabeled inputs,
a first distance of the unlabeled input to the labeled inputs of the training data set, and
a second distance of the unlabeled input to other unlabeled inputs of the pool data set;
submit the refinement subset to a labeling process to produce a labeled subset;
train the neural network based on the labeled subset to produce a trained neural network; and
classify new data using the trained neural network.

23. An apparatus that classifies data, comprising:
a memory storing a pool data set including unlabeled inputs; and
processing circuitry configured to:
identify a refinement subset of the unlabeled inputs of the pool data set by determining, for each unlabeled input of the pool data set, a distance of the unlabeled input to other unlabeled inputs of the pool data set;
submit the refinement subset to a labeling process to produce a labeled subset;
train the neural network based on the labeled subset to produce a trained neural network; and
classify new data using the trained neural network.
